(19) United States
(12) Patent Application Publication
(10) Pub. No.: US 2024/0351936 A1
(43) Pub. Date: Oct. 24, 2024

(54) CHEMICALLY STRENGTHENED OPTICAL GLASS

(71) Applicant: OHARA INC., KANAGAWA (JP)

(72) Inventors: SAYA KIKKAWA, KANAGAWA (JP); KEISUKE SHIMAMURA, KANAGAWA (JP)

(21) Appl. No.: 18/686,875

(22) PCT Filed: Jul. 12, 2022
(86) PCT No.: PCT/JP2022/027472

§ 371 Date: Feb. 27, 2024

(30) Foreign Application Priority Data
Aug. 27, 2021 (JP) 2021-139373

(51) Int. Cl. C03C 3/097; C03C 3/062

(52) U.S. Cl. CPC C03C 3/097; C03C 3/062

(57) ABSTRACT

Provided is a chemically strengthened optical glass having an improved impact resistance and a high hardness while maintaining the refractive index, the Abbe number and the transmittance required in the conventional optical glasses. The chemically strengthened optical glass has a compressive stress layer on the surface thereof, contains, in mass % in terms of oxide, 20.0-50.0% of an SiO₂ component, 10.0-45.0% of a TiO₂ component and 0.1-20.0% of an Na₂O component, has a refractive index (nd) of 1.65-1.85, and is characterized by having an impact resistance of 8 cm or more in a sandpaper falling ball test in which a 16.0 g SUS ball is dropped thereon.

### FIELD OF THE DISCLOSURE

The present disclosure relates to chemically strengthened optical glass including a compressive stress layer on a surface.

### BACKGROUND OF THE DISCLOSURE

In recent years, a wearable terminal utilized for an artificial reality (AR) and a virtual reality (VR) such as eyeglasses with a projector, an eyeglass-type display, a goggle-type display, a virtual reality display device, an augmented reality display device, and a virtual image display device; a vehicle-mounted camera, and the like are attracting attention.

Such a wearable terminal and a vehicle-mounted camera are expected to be used in harsh external environments, and thus, there is a need for optical glass that is not easily broken because of a higher impact resistance and has higher hardness so that such equipment can withstand a severer use while maintaining a high refractive index and an Abbe number required for conventional optical glass.

Patent Document 1 discloses a high refractive index, high dispersion glass having a refractive index (nd) of 1.7 or more and an Abbe number (vd) of 20 or more and 30 or less, aimed at digitalization and high definition of optical equipment. However, such glass is not intended to be used in harsh external environments, and Patent Document 1 does not disclose optical glass having a high hardness with an aim of an impact resistance. Further, at the time of filing of Patent Document 1, modern cutting-edge technologies such as VR and AR were not widely used, and further, wide use of an autonomous vehicle driving and a vehicle-mounted camera functioning as a central role in a “surrounding recognition sensor” to ensure safety has rapidly increased in recent years. Therefore, at the time of filing of Patent Document 1, the optical glass with high hardness and improved impact resistance was not envisaged.

Furthermore, if the high strength optical glass with improved impact resistance is used, it is possible to decrease a thickness of glass used for an optical lens, and thus, it is possible to decrease a thickness and a size of such optical glass.

### PRIOR ART DOCUMENT

### Patent Document

[Patent Document 1] Japanese Unexamined Patent Application Publication No. 2009-203134

### SUMMARY OF THE DISCLOSURE

### Technical Problem

The present disclosure is to obtain highly hard optical glass having improved impact resistance while maintaining a refractive index and an Abbe number required for conventional optical glass.

### Solution to Problem

In order to solve the above problem, the inventors conducted intensive testing and research on a glass substrate including a compressive stress layer on a surface, which is obtained by chemically strengthening optical glass. As a result, the inventors found a glass composition and formulation suitable for producing a highly hard optical glass having an impact resistance of 8 cm or more, as determined using a sandpaper falling ball test in which a 16.0 g SUS ball is dropped, and completed the present disclosure.

In addition, as a result of intensive testing and research conducted by the inventors to solve the above problem, on a glass substrate including a compressive stress layer on a surface, which is obtained by chemically strengthening optical glass, the inventors found a glass composition and formulation suitable for producing a highly hard optical glass satisfying the following expression,

$$[ Height at which glass substrate does not break ( after chemical strengthening ) ] - [ \text{} Height at which glass substrate does not break ( before chemical strengthening ) ] \geq 2. cm ,$$

as determined using a sandpaper falling ball test in which a 16.0 g SUS ball is dropped, and completed the present disclosure.

Specifically, the present disclosure provides the following.
(1)

A chemically strengthened optical glass including a compressive stress layer on a surface, the chemically strengthened optical glass including, in mass % in terms of oxide,

20.0 to 50.0% of an SiO₂ component,

10.0 to 45.0% of a TiO₂ component, and

0.1 to 20.0% of an Na₂O component, in which

the chemically strengthened optical glass has a refractive index (nd) of 1.65 to 1.85, and an impact resistance of 8 cm or more, as determined using a sandpaper falling ball test in which a 16.0 g SUS ball is dropped.
(2)

A chemically strengthened optical glass including a compressive stress layer on a surface, the chemically strengthened optical glass including, in mass % in terms of oxide,

20.0 to 50.0% of an SiO₂ component,

10.0 to 45.0% of a TiO₂ component, and

0.1 to 20.0% of an Na₂O component, in which

the chemically strengthened optical glass has a refractive index (nd) of 1.65 to 1.85, and an impact resistance satisfying the following expression,

$$[ Height at which glass substrate does not break ( after chemical strengthening ) ] - [ \text{} Height at which glass substrate does not break ( before chemical strengthening ) ] \geq 2. cm ,$$

as determined using a sandpaper falling ball test in which a 16.0 g SUS ball is dropped.
(3)

The chemically strengthened optical glass according to (1) or (2), further including, in mass % in terms of oxide,

3.0 to 20.0% of an Nb₂O₅ component, and

0 to 20.0% of BaO.
(4)

The chemically strengthened optical glass according to any one of (1) to (3), further including, in mass % in terms of oxide,

0 to 15.0% of Al₂O₃,

0 to 15.0% of ZrO₂,

0 to 10.0% of Li₂O,

0 to 15.0% of K₂O, and

0 to 1.0% of Sb₂O₃.
(5)

The chemically strengthened optical glass according to any one of (1) to (4), in which the chemically strengthened optical glass has an Abbe number (vd) of 20.0 to 33.0.

### Effects of the Disclosure

According to the present disclosure, it is possible to provide chemically strengthened optical glass including a compressive stress layer and having high hardness and improved impact resistance while maintaining a high refractive index and Abbe number.

### BRIEF DESCRIPTION OF THE DRAWINGS

FIG. 1 shows an EDX-ray analysis result of a fracture surface of Example 5-A.

FIG. 2 shows an EDX-ray analysis result of a fracture surface of Example 7-B.

### DETAILED DESCRIPTION OF THE EXEMPLARY EMBODIMENTS

A composition range of each component included in chemically strengthened optical glass of the present disclosure will be described below. Throughout this specification, a content of each component is expressed in mass % relative to the total mass of a composition in terms of oxide, unless otherwise specified. Here, the “composition in terms of oxide” is based on the assumption that raw materials of the glass components of the present disclosure such as oxides, combined salts, and metal fluorides are all decomposed and converted to oxides when melted, and is a composition when each component contained in the glass is expressed in mass % relative to the total mass of the generated oxides defined as 100 mass %.

### Glass Component

The chemically strengthened optical glass of the present disclosure is characterized by including a compressive stress layer on a surface and including, in mass % in terms of oxide, 20.0 to 50.0% of an SiO₂ component, 10.0 to 45.0% of a TiO₂ component, and 0.1 to 20.0% of an Na₂O component.

### Essential Components and Optional Components

The SiO₂ component is a component for forming a network structure of the glass, is a component for suppressing the devitrification (generation of crystals), which is undesirable for optical glass, and is an essential component of the chemically strengthened optical glass of the present disclosure.

In particular, when the content of the SiO₂ component is set to 20.0% or more, it is possible to produce a stable optical glass with high strength. Therefore, a lower limit of the content of the SiO₂ component is preferably 20.0% or more, more preferably 23.0% or more, and still more preferably more than 25.0%.

On the other hand, when the content of the SiO₂ component is set to 50.0% or less, it is possible to suppress an excessive increase in viscosity and deterioration of meltability, and also to suppress a decrease in refractive index. Further, it is possible to suppress a decrease in the degree of chemical strengthening. Therefore, an upper limit of the content of the SiO₂ component is preferably 50.0% or less, more preferably 47.0% or less, and still more preferably 43.0% or less.

The TiO₂ component is a component for increasing an refractive index and chemical durability (acid resistance), and is an essential component of the chemically strengthened optical glass of the present disclosure.

In particular, when the content of the TiO₂ component is set to 10.0% or more, it is possible to achieve a desired refractive index, Abbe number, and the like of the glass. Therefore, a lower limit of the content of the TiO₂ component is preferably 10.0% or more, more preferably 13.0% or more, and still more preferably more than 15.0%.

On the other hand, when the content of the TiO₂ component is set to 45.0% or less, it is possible to suppress the devitrification of the glass and a decrease in transmittance of glass to visible light (in particular, a wavelength of 500 nm or less). Therefore, an upper limit of the content of the TiO₂ component is preferably 45.0% or less, more preferably 40.0% or less, still more preferably 35.0% or less, yet still even more preferably 33.0% or less.

The Na₂O component is a component for improving a meltability of glass, a component utilized for ion exchange in chemical strengthening as will be described later, and is an essential component in the chemically strengthened optical glass of the present disclosure.

In particular, when the content of Na₂O component is set to 0.1% or more, an exchange reaction between a potassium component (potassium ion) with a large ionic radius in a molten salt and a sodium component (sodium ion) with a small ionic radius in a substrate progresses, and as a result, a compressive stress is generated on a substrate surface. Therefore, a lower limit of the content of the Na₂O component is preferably 0.1% or more, more preferably 0.5% or more, and still more preferably 5.0% or more.

On the other hand, when the content of Na₂O component is set to 20.0% or less, it is possible to prevent a decrease of a refractive index of the glass and it is possible to suppress the devitrification of the glass. Therefore, an upper limit of the content of the Na₂O component is preferably 20.0% or less, more preferably 17.0% or less, still more preferably 15.0% or less, and yet still more preferably less than 14.0%.

The Nb₂O₅ component is a component for increasing the refractive index and stabilizing the glass, and is an optional component of the chemically strengthened optical glass of the present disclosure.

In particular, when the content of the Nb₂O₅ component is set to 3.0% or more, it is possible to improve the devitrification resistance. It is also possible to suppress a decrease in hardness due to a salt bath during chemical strengthening. Therefore, a lower limit of the content of the Nb₂O₅ component is preferably 3.0% or more, more preferably 4.0% or more, still more preferably more than 5.0%, and yet still more preferably 6.0% or more.

On the other hand, when the content of the Nb₂O₅ component is set to 20.0% or less, it is possible to suppress the devitrification due to an excessive content. Therefore, an upper limit of the content of the Nb₂O₅ component is preferably 20.0% or less, more preferably 17.0% or less, still more preferably 15.0% or less, and yet still more preferably 13.0% or less.

The K₂O component is a component for adjusting the refractive index and the Abbe number while adjusting the meltability of the glass if contained in an amount exceeding 0%, and is a component that can improve a surface compressive stress in the chemical strengthening. Therefore, a lower limit of the content of the K₂O component is preferably 0% or more, more preferably more than 0%, still more preferably 0.5% or more, and yet still more preferably 2.0% or more.

On the other hand, when the content of the K₂O component is set to 15.0% or less, it is possible to minimize a decrease of the refractive index of the glass and it is possible to suppress the devitrification of the glass. Therefore, an upper limit of the content of the K₂O component is preferably 15.0% or less, more preferably 10.0% or less, still more preferably 8.0% or less, yet still more preferably 7.5% or less.

The Li₂O component is a component for adjusting the refractive index and the Abbe number while adjusting the meltability of the glass if contained in an amount exceeding 0%, and is a component used for an ion exchange in the chemical strengthening. Therefore, a lower limit of the content of the Li₂O component is preferably 0% or more, more preferably more than 0%, still more preferably 0.1% or more, yet still more preferably 0.3% or more, and even more preferably 0.5% or more.

On the other hand, when the content of the Li₂O component is set to 10.0% or less, it is possible to suppress a decrease in the refractive index and the devitrification due to an excessive content. Therefore, an upper limit of the content of the Li₂O component is preferably 10.0% or less, more preferably 8.0% or less, and still more preferably 7.5% or less.

The BaO component is a component for increasing the refractive index of the glass when if contained in an amount exceeding 0%, and is an optional component in the chemically strengthened optical glass of the present disclosure. When the BaO component is contained more than 0%, it is possible to suppress a decrease in hardness due to a salt bath during the chemical strengthening. Therefore, a lower limit of the content of the BaO component is preferably 0% or more, more preferably more than 0%, still more preferably 1.0% or more, and yet still more preferably 2.0% or more.

On the other hand, when the content of the BaO component is set to 20.0% or less, it is possible to suppress deterioration of the devitrification and deterioration of the chemical strengthening resistance, and to prevent a glass surface from becoming brittle. Therefore, an upper limit of the content of the BaO component is preferably 20.0% or less, more preferably 15.0% or less, and still more preferably 12.0% or less.

The MgO component, the CaO component, and the SrO component are components that increase the refractive index of the glass if contained in an amount exceeding 0%, and are optional components in the chemically strengthened optical glass of the present disclosure.

On the other hand, when the content of each of the MgO component, the CaO component, and the SrO component is set to 20.0% or less, it is possible to suppress a decrease in hardness due to a salt bath during the chemical strengthening. Therefore, an upper limit of the content of each of the MgO component, the CaO component, and the SrO component is preferably 20.0% or less, more preferably 15.0% or less, and still more preferably 10.0% or less.

In particular, from the viewpoint of productivity, to suppress deterioration of the devitrification, it is desired that the content of the CaO component is preferably less than 0.5%, and more preferably less than 0.3%.

The ZnO component is a component for increasing the refractive index of the glass if contained in an amount exceeding 0%, and is an optional component in the chemically strengthened optical glass of the present disclosure.

On the other hand, when the content of the ZnO component is set to 15.0% or less, it is possible to suppress a decrease in hardness due to a salt bath during the chemical strengthening. Therefore, an upper limit of the content of the ZnO component is preferably 15.0% or less, more preferably 10.0% or less, and still more preferably less than 8.0%.

The Al₂O₃ component is an effective component for increasing a chemical durability of the glass and improving the devitrification resistance of molten glass if contained in an amount exceeding 0%, and is an optional component in the chemically strengthened optical glass of the present disclosure.

On the other hand, when the content of the Al₂O₃ component is set to 15.0% or less, it is possible to lower a liquidus temperature of the glass and suppress the devitrification due to an excessive content. Therefore, an upper limit of the content of the Al₂O₃ component is preferably 15.0% or less, more preferably 10.0% or less, and still more preferably 5.0% or less.

The ZrO₂ component is a component for increasing the refractive index of the glass if contained in an amount exceeding 0%, and is an optional component in the chemically strengthened optical glass of the present disclosure.

On the other hand, when the content of the ZrO₂ component is set to 15.0% or less, it is possible to suppress the devitrification due to an excessive content of the ZrO₂ component. Therefore, an upper limit of the content of the ZrO₂ component is preferably 15.0% or less, more preferably 10.0% or less, and still more preferably 5.0% or less.

The B₂O₃ component is an optional component, and can promote formation of stable glass and improve the devitrification resistance, if contained in an amount exceeding 0%.

On the other hand, when the content of the B₂O₃ component is set to 15.0% or less, it is possible to suppress the devitrification due to an excessive content of the B₂O₃ component. Therefore, an upper limit of the content of the B₂O₃ component is preferably 15.0% or less, more preferably 10.0% or less, and still more preferably 5.0% or less.

If at least either one of the La₂O₃ component, the Gd₂O₃ component, the Y₂O₃ component, and the Yb₂O₃ component, which are optional components, is contained in an amount of more than 0%, it is possible to increase the refractive index and reduce a partial dispersion ratio.

On the other hand, when the La₂O₃ component, Gd₂O₃ component, the Y₂O₃ component, and the Yb₂O₃ component are contained in large amounts, the liquidus temperature decreases to cause the devitrification of the glass.

In particular, when the content of each of the La₂O₃ component, the Gd₂O₃ component, the Y₂O₃ component, and the Yb₂O₃ component is set to 10.0% or less, it is possible to suppress devitrification and coloring. Therefore, an upper limit of the content of each of the La₂O₃ component, the Gd₂O₃ component, the Y₂O₃ component, and the Yb₂O₃ component is preferably 10.0% or less, more preferably 8.0% or less, still more preferably 5.0% or less, and most preferably 3.0% or less.

The WO₃ component is an optional component for increasing the refractive index, lowering the Abbe number, and improving a solubility of a glass raw material.

On the other hand, when the content of the WO₃ component is set to 10.0% or less, it is possible to minimize an increase the partial dispersion ratio of the glass and it is possible to reduce the coloring of the glass and increase an internal transmittance. Therefore, an upper limit of the content of the WO₃ component is preferably 10.0% or less, more preferably 5.0% or less, still more preferably 3.0% or less, and most preferably 1.0% or less.

The P₂O₅ component is an optional component for enhancing stability of the glass.

On the other hand, when the content of the P₂O₅ component is set to 5.0% or less, it is possible to reduce an increase in the partial dispersion ratio due to an excessive inclusion of the P₂O₅ component. Therefore, an upper limit of the content of the P₂O₅ component is preferably 5.0% or less, more preferably 3.0% or less, and still more preferably 1.0% or less.

The Ta₂O₅ component is an optional component for increasing the refractive index, lowering the Abbe number and partial dispersion ratio, and improving the devitrification resistance.

In particular, when the content of the Ta₂O₅ component is set to 10.0% or less, the usage amount of Ta₂O₅ component, which is a rare mineral resource, is reduced, and the glass will melt more easily at lower temperatures, which will reduce a glass production cost. Furhter, the devitrification of the glass due to an excessive inclusion of the Ta₂O₅ component can be suppressed by doing so. Therefore, an upper limit of the content of the Ta₂O₅ component is preferably 10.0% or less, more preferably 5.0% or less, still more preferably 3.0% or less, and still more preferably 1.0% or less. In particular, from the viewpoint of reducing a material cost of the glass, the Ta₂O₅ component may not necessarily be contained.

The GeO₂ component is an optional component capable of increasing the refractive index and suppressing the devitrification. When the content of the GeO₂ component is set to 10.0% or less, the usage amount of an expensive GeO₂ component is reduced, so that it is possible to reduce the material cost of the glass. Therefore, an upper limit of the content of the GeO₂ component is preferably 10.0% or less, more preferably 5.0% or less, still more preferably 3.0% or less, and yet still more preferably 1.0% or less.

The Ga₂O₃ component is an optional component capable of increasing the refractive index and improving the devitrification resistance.

On the other hand, when the content of the Ga₂O₃ component is set to 10.0% or less, it is possible to suppress the devitrification due to an excessive inclusion of the Ga₂O₃ component. Therefore, an upper limit of the content of the Ga₂O₃ component is preferably 10.0% or less, more preferably 5.0% or less, still more preferably 3.0% or less, and yet still more preferably 1.0% or less.

The Bi₂O₃ component is an optional component capable of increasing the refractive index, lowering the Abbe number, and lowering a glass transition point. When the content of the Bi₂O₃ component is set to 10.0% or less, it is possible to minimize an increase of the partial dispersion ratio and it is possible to decrease the coloring of the glass, and to increase the internal transmittance. Therefore, an upper limit of the content of the Bi₂O₃ component is preferably 10.0% or less, more preferably 5.0% or less, still more preferably 3.0% or less, yet still more preferably 1.0% or less.

The TeO₂ component is an optional component capable of increasing the refractive index, lowering the partial dispersion ratio, and lowering the glass transition point. When the content of the TeO₂ component is set to 10.0% or less, it is possible to suppress the coloring of the glass and to increase the internal transmittance. Further, when the use of the expensive TeO₂ component is reduced, it is possible to obtain glass with lower material costs. Therefore, an upper limit of the content of the TeO₂ component is preferably 10.0% or less, more preferably 5.0% or less, still more preferably 3.0% or less, and yet still more preferably 1.0% or less. In particular, from the viewpoint of reducing the material cost of the glass, the TeO₂ component may not be necessarily contained.

SnO₂ is an optional component for clarifying (defoaming) molten glass and increasing a visible light transmittance of the glass. When the content of SnO₂ is set to 1.0% or less, it is possible to minimize the coloring of the glass or the devitrification of the glass due to the reduction of the molten glass. Further, alloying between SnO₂ and a melting equipment (particularly, a noble metal such as Pt) is reduced, and thus, it is possible to extend the life of the melting equipment. Therefore, an upper limit of the content of SnO₂ is preferably 1.0% or less, more preferably 0.5% or less, and still more preferably 0.1% or less.

The Sb₂O₃ component is an optional component capable of defoaming the molten glass if contained in an amount exceeding 0%.

On the other hand, when the content of the Sb₂O₃ component is set to 1.0% or less, it is possible to suppress a decrease in transmittance in a short wavelength region of a visible light region, solarization of the glass, and lowering of internal quality. Therefore, the content of the Sb₂O₃ component is preferably 1.0% or less, more preferably less than 1.0%, still more preferably less than 0.7%, yet still more preferably 0.5% or less, and most preferably 0.4% or less.

Rn₂O components (where Rn is one or more selected from the group consisting of Li, Na, and K) can improve the meltability of the glass when the sum of the contents (mass sum) is 5.0% or more. Therefore, a lower limit of the sum of Rn₂O components is preferably 5.0% or more, more preferably 7.0% or more, and still more preferably 10.0% or more.

On the other hand, when the sum of contents (mass sum) of Rn₂O components is set to 30.0% or less, it is possible to suppress a decrease in the refractive index and to suppress the devitrification due to an excessive content. Therefore, the upper limit is preferably 30.0% or less, more preferably 25.0% or less, still more preferably 23.0% or less, and most preferably 20.0% or less.

When the sum of the contents of RO components (where R is one or more selected from the group consisting of Mg, Ca, Sr, and Ba) exceeds 0%, it is possible to improve a low-temperature meltability. Therefore, a lower limit of the sum of the contents of RO components is preferably more than 0%, more preferably 1.0% or more, and still more preferably 2.0% or more.

On the other hand, the sum of the contents of the RO components is preferably 20.0% or less in order to suppress a decrease in the devitrification resistance due to an excessive content. Therefore, an upper limit of the mass sum of the RO components is preferably 20.0% or less, more preferably 15.0% or less, still more preferably 14.0% or less, and yet still more preferably 13.0% or less.

When the sum of the contents (mass sum) of Ln₂O₃ components (where, Ln is one or more selected from the group consisting of La, Gd, Y, and Yb) exceeds 0%, it is possible to facilitate obtaining of a high refractive index.

On the other hand, when the sum of the contents (mass sum) of Ln₂O₃ components is set to 15.0% or less, it is possible to suppress the devitrification due to an excessive content. Therefore, the upper limit is preferably 15.0% or less, more preferably 10.0% or less, and still more preferably 5.0% or less.

When the mass sum of TiO₂+BaO+Nb₂O₅ is 30.0% or more, it is possible to increase the refractive index. Therefore, a lower limit of the mass sum of TiO₂+BaO+Nb₂O₅ is preferably 30.0% or more, more preferably 33.0% or more, and still more preferably 35.0% or more.

On the other hand, when the mass sum of TiO₂+BaO+Nb₂O₅ is set to 60.0% or less, it is possible to suppress a decrease in transmittance of glass to visible light (in particular, at a wavelength of 500 nm or less). Therefore, an upper limit of the mass sum of TiO₂+BaO+Nb₂O₅ is preferably 60.0% or less, more preferably 57.0% or less, still more preferably 55.0% or less, and most preferably less than 50.0%.

When the mass ratio of K₂O/Na₂O is more than 0, chemical strengthening may be facilitated. Therefore, a lower limit of the mass ratio of K₂O/Na₂O is preferably more than 0, more preferably 0.10 or more, and still more preferably 0.20 or more.

On the other hand, when the mass ratio of K₂O/Na₂O is set to 1.00 or less, it is possible to suppress the devitrification of the glass. Therefore, an upper limit of the mass ratio of K₂O/Na₂O is preferably 1.00 or less, more preferably 0.95 or less, and still more preferably 0.90 or less.

When the mass sum of Nb₂O₅+BaO is set to 8.0% or more, it is possible to suppress a decrease in hardness due to a salt bath during the chemical strengthening. Therefore, a lower limit of the mass sum of Nb₂O₅+BaO is preferably 8.0% or more, more preferably more than 10.0%, still more preferably 13.0% or more, and yet still more preferably 15.0% or more.

On the other hand, when the mass sum of Nb₂O₅+BaO is set to 30.0% or less, it is possible to suppress deterioration of the devitrification of the glass. Therefore, an upper limit of the mass sum of Nb₂O₅+BaO is preferably 30.0% or less, more preferably 27.0% or less, and still more preferably 25.0% or less.

When the mass sum of SiO₂+RO is set to 35.0% or more, it is possible to produce stable optical glass. Therefore, a lower limit of the mass sum of SiO₂+RO is preferably 35.0% or more, more preferably 38.0% or more, and still more preferably 40.0% or more.

On the other hand, when the mass sum of SiO₂+RO is set to 60.0% or less, it is possible to suppress a decrease in the refractive index and to facilitate the chemical strengthening. Therefore, an upper limit of the mass sum of SiO₂+RO is preferably 60.0% or less, more preferably 57.0% or less, and still more preferably 54.0% or less.

When the mass sum of SiO₂+TiO₂+Na₂O is set to 50.0% or more, it is possible to stably produce glass that has a high refractive index and that can be chemically strengthened. Therefore, a lower limit of the mass sum SiO₂+TiO₂+Na₂O is preferably 50.0% or more, more preferably 55.0% or more, still more preferably 60.0% or more, and yet still more preferably 63.5% or more.

On the other hand, when the mass sum of SiO₂+TiO₂+Na₂O is set to 90.0% or less, it is possible to suppress deterioration of the devitrification of the glass. Therefore, an upper limit of the mass sum of SiO₂+TiO₂+Na₂O is preferably 90.0% or less, more preferably 85.0% or less, and still more preferably 81.0% or less.

When the mass sum of SiO₂+Na₂O+BaO is set to 45.0% or more, it is possible to stably produce optical glass that can be chemically strengthened. Therefore, a lower limit of the mass sum of SiO₂+Na₂O+BaO is preferably 45.0% or more, more preferably 48.0% or more, still more preferably 50.0% or more, and yet still more preferably 51.5% or more.

On the other hand, when the mass sum of SiO₂+Na₂O+BaO is set to 70.0% or less, it is possible to suppress a decrease in the refractive index. Therefore, an upper limit of the mass sum of SiO₂+Na₂O+BaO is preferably 70.0% or less, more preferably 68.0% or less, and still more preferably 65.0% or less.

When the mass ratio of (ZrO₂+Na₂O)/BaO is set to 0.20 or more, it is possible to obtain a glass material having excellent devitrification and improved meltability. Therefore, a lower limit of the mass ratio of (ZrO₂+Na₂O)/BaO is preferably 0.20 or more, more preferably 0.50 or more, still more preferably 0.60 or more, and yet still more preferably 0.80 or more.

On the other hand, when the mass ratio of (ZrO₂+Na₂O)/BaO is set to 20.0 or less, it is possible to prevent deterioration of the devitrification due to an excessive addition of components. Therefore, an upper limit of the mass ratio of (ZrO₂+Na₂O)/BaO is preferably 20.0 or less, more preferably 18.0 or less, still more preferably 15.0 or less, yet still more preferably 13.0 or less.

In particular, from the viewpoint of chemical strengthening, it is desirable that in order to easily increase the hardness due to chemical strengthening, the mass ratio of (ZrO₂+Na₂O)/BaO is more than 0.86.

When the mass sum of SiO₂+Na₂O is 33.0% or more, it is possible to stably produce optical glass that can be chemically strengthened. Therefore, a lower limit of the mass sum of SiO₂+Na₂O is preferably 33.0% or more, more preferably 35.0% or more, and still more preferably 38.0% or more.

On the other hand, when the mass sum of SiO₂+Na₂O is set to 65.0% or less, it is possible to suppress a decrease in the refractive index. Therefore, an upper limit of the mass sum of SiO₂+Na₂O is preferably 65.0% or less, more preferably 60.0% or less, still more preferably 58.0% or less, and most preferably 55.0% or less.

### Production Method

The chemically strengthened optical glass of the present disclosure is produced, for example, as follows. That is, raw materials such as oxides, carbonates, nitrates, and hydroxides are uniformly mixed so that each component is within a predetermined content range. Next, the produced mixture is placed into a platinum crucible and melted in an electric furnace in a temperature range from 1200 to 1500° C. for 1 to 4 hours depending on the melting difficulty of the glass composition. Subsequently, the molten mixture is stirred and homogenized, and then, cooled to an appropriate temperature and casted into a mold. The mold is slowly cooled to manufacture the optical glass. Finally, the manufactured glass is chemically strengthened.

### Chemical Strengthening

Chemically strengthened glass is glass strengthened by a method for strengthening the surface of glass, which is called a chemical strengthening method, an ion exchange strengthening method, or the like. In the chemically strengthened optical glass according to the present disclosure, the surface of the glass is subjected to an ion exchange treatment to form a surface layer (compressive stress layer) in which compressive stress remains, and thus, the glass surface is strengthened. The ion exchange is generally performed at a temperature equal to or lower than the glass transition point. In the ion exchange, alkali metal ions having a small ionic radius (typically, lithium ions and sodium ions) in the glass surface are replaced by alkali ions having a larger ionic radius (typically, sodium ions or potassium ions for lithium ions, and potassium ions for sodium ions). Thus, the compressive stress remains on the surface of the glass, which improves the strength of the glass.

The chemical strengthening method may be implemented according to the following steps, for example. A glass base material is contacted to or immersed in a molten salt of a salt containing potassium or sodium, for example, potassium nitrate (KNO₃), sodium nitrate (NaNO₃) or a mixed salt or a complex salt thereof. The treatment of contacting or immersing the glass base material to or in the molten salt (chemical strengthening treatment) may be performed in one stage or in two stages.

For example, in the case of the two-stage chemical strengthening treatment, firstly, the glass base material is contacted to or immersed in a sodium salt or a mixed salt of potassium and sodium heated at 370° C. to 550° C. for 1 to 1440 minutes, preferably 90 to 800 minutes. Subsequently, secondly, the resultant glass base material is contacted to or immersed in a potassium salt or a mixed salt of potassium and sodium heated at 350° C. to 550° C. for 1 to 1440 minutes, preferably 60 to 800 minutes.

In the case of the one-stage chemical strengthening treatment, the glass base material is contacted to or immersed in a salt containing potassium or sodium or a mixed salt thereof heated at 370° C. to 550° C. for 1 to 1440 minutes, preferably 60 to 800 minutes.

The heat strengthening method is not particularly limited, but, for example, the glass base material may be heated to 300° C. to 600° C., and then, be subjected to rapid cooling such as water cooling and/or air cooling to form the compressive stress layer by a temperature difference between the surface and the inside of the glass substrate. Further, when the heat strengthening method is combined with the above chemical treatment method, it is possible to more effectively form the compressive stress layer.

The ion implantation method is not particularly limited, but, for example, any type of ion may be caused to collide with the surface of the glass base material with an acceleration energy and an acceleration voltage that do not destroy the surface of the base material, to implant the ions into the surface of the base material. Thereafter, if heat treatment is performed as necessary, it is possible to form the compressive stress layer on the surface in a same manner as in the other methods.

### Refractive Index and Abbe Number

The chemically strengthened optical glass of the present disclosure preferably has a high refractive index. In particular, a lower limit of the refractive index (nd) of the chemically strengthened optical glass of the present disclosure is preferably 1.65 or more, more preferably 1.67 or more, and still more preferably 1.68 or more.

On the other hand, an upper limit of the refractive index preferably has an upper limit of 1.85 or less, more preferably 1.83 or less, still more preferably 1.80 or less, and yet still more preferably 1.79 or less.

A lower limit of the Abbe number (vd) of the chemically strengthened optical glass of the present disclosure is preferably 20.0 or more, more preferably 22.0 or more, and still more preferably 23.0 or more. On the other hand, an upper limit of the Abbe number preferably has a lower limit of 33.0 or less, more preferably 30.0 or less, and still more preferably 28.0 or less.

It is preferable that the optical glass of the present disclosure has a high visible light transmittance, particularly a high transmittance to light on the short wavelength side of visible light, and thereby has little coloring.

In particular, an upper limit of the shortest wavelength (λ5) at which a 10-mm thick sample of the optical glass of the present disclosure exhibits spectral transmittance of 5% is preferably 400 nm or less, more preferably 390 nm or less, and still more preferably 380 nm or less.

As a result of these, an absorption edge of the glass is in or near the ultraviolet region, and the transparency of the glass to visible light is increased, so that it is possible to preferably use such optical glass for a light transmissive optical element such as a lens.

### Specific Gravity

From the viewpoint of contributing to the weight reduction of optical elements and optical equipment, an upper limit of the specific gravity of the optical glass of the present disclosure is preferably 4.00 or less, more preferably 3.80 or less, still more preferably 3.50 or less, and yet still more preferably 3.30 or less.

On the other hand, in many cases, the specific gravity of the optical glass of the present disclosure is generally 2.00 or more, more specifically 2.50 or more, and still more specifically 3.00 or more.

A ball drop test using sandpaper was conducted on a crystallized glass substrate by using the following method. The ball drop test simulates falling onto asphalt.

Sandpaper with a roughness of #180 was laid on a base made of SUS, and a crystallized glass substrate (φ36×2 mm) was placed thereon. Thereafter, a 16.0 g SUS ball was freely dropped onto the substrate from a height of 60 mm (6 cm) from the substrate. If the substrate did not break after the ball dropped, the same test was conducted again using a height increased by 20 mm (2 cm) and visual observation was conducted. This test was repeated until the crystallized glass substrate broke. Break here means visually observable division, cracking, chipping, or fissure (breaking). Each test was performed three times, and an average height before the break was calculated.

From the viewpoint of contributing to the impact resistance of wearable terminals, vehicle-mounted cameras, and the like, it is preferable that the glass substrate of the present disclosure has impact resistance of 8 cm or more, as determined using a sandpaper falling ball test in which a 16.0 g SUS ball is dropped. Therefore, the chemically strengthened optical glass of the present disclosure has impact resistance of 8 cm or more, more preferably 12 cm or more, and still more preferably 14 cm or more, as determined using the sandpaper falling ball test in which a 16.0 g SUS ball is dropped.

The chemically strengthened optical glass of an example of the present disclosure preferably has impact resistance determined using the sandpaper falling ball test in which a 16.0 g SUS ball is dropped, which satisfies the following expression.

$$[ Height at which glass substrate does not break ( after chemical strengthening ) ] - [ \text{} Height at which glass substrate does not break ( before chemical strengthening ) ] \geq 2. cm$$

Therefore, in the chemically strengthened optical glass of the present disclosure, [Height at which glass substrate does not break (after chemical strengthening)]−[Height at which glass substrate does not break (before chemical strengthening)] is preferably 2.0 cm or more, more preferably 2.5 cm or more, still more preferably 3.0 cm or more, and yet still more preferably 4.0 cm or more.

The following examples illustrate the present disclosure in detail for illustrative purposes. It should be noted, however, that these examples are for illustrative purposes only and that many modifications may be made by those skilled in the art without departing from the spirit and scope of the present disclosure.

As Examples (No. 1 to No. 9) and Comparative Example 1, glasses having various compositions as listed in Table 1 were produced. High purity materials used for a typical chemically strengthened optical glass such as oxide, hydroxide, carbonate, nitrate, fluoride, and a metaphosphoric acid compound each corresponding to raw materials of each component were selected and used as the raw materials. The materials were weighted and mixed to achieve ratios of the compositions of each Examples shown in Table 1, and then, placed in a platinum crucible. The materials were melted in an electric furnace for one to four hours with a temperature range of 1200 to 1400° C. depending on the melting difficulty of the glass composition, and after stirring to homogenize, the temperature was lowered to an appropriate temperature, then the mixture was casted into a mold and the like. Finally, the glass was slowly cooled. In this manner, the glasses of Examples No. 1 to 9 and Comparative Example 1 were produced. Table 1 shows the measured refractive index (nd), Abbe number (vd), transmittance (λ5), and specific gravity of each of these glasses.

The refractive indexes (nd) and the Abbe numbers (vd) of the glasses were shown as values measured against a d-line (587.56 nm) of a helium lamp in accordance with a V block method specified in JIS B 7071-2:2018. Further, in calculating the Abbe numbers (vd), the values of the refractive index for the d-line, a refractive index (n_{F}) for F-line (486.13 nm) of a hydrogen lamp, a refractive index (nc) for C line (656.27 nm), and the formula of Abbe number (vd)=[(nd−1)/(n_{F}−n_{C})] were used.

Here, the refractive index (nd) and the Abbe number (vd) were evaluated based on measurement on glass obtained using a slow cooling rate of −25° C./hr.

The transmittance of the glass was measured according to the Japan Optical Glass Manufacturers' Association standard JOGIS02-2019. Further, in the present disclosure, the presence or absence and degree of coloring of the glass was evaluated by measuring the transmittance of the glass. Specifically, the spectral transmittance of 200 to 800 nm of a parallel polished product with a thickness of 10±0.1 mm was measured in accordance with JIS Z8722, and a wavelength (λ5) at which the spectral transmittance was 5% was evaluated.

A specific gravity p of the glasses of Examples and Comparative Examples was measured based on the Japan Optical Glass Manufacturers' Association standard JIS Z8807: 2012 “Methods of Measuring Specific Gravity of Optical Glass”.

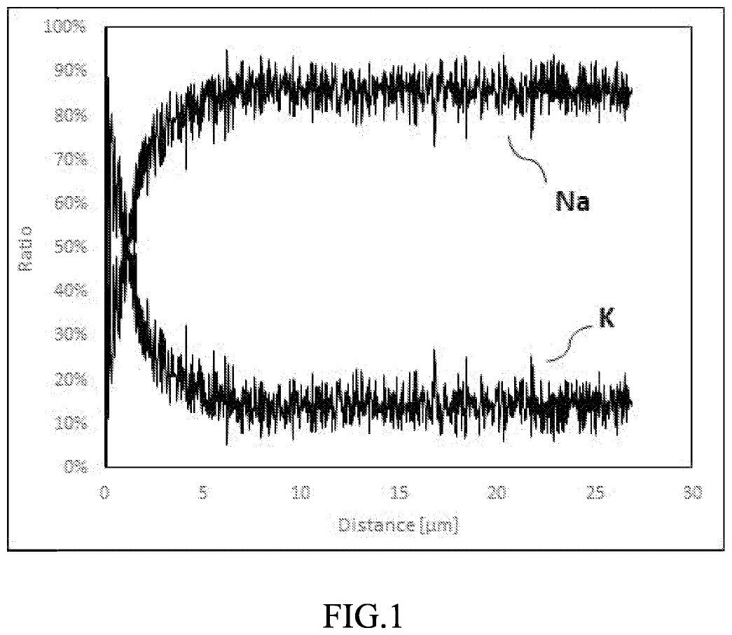

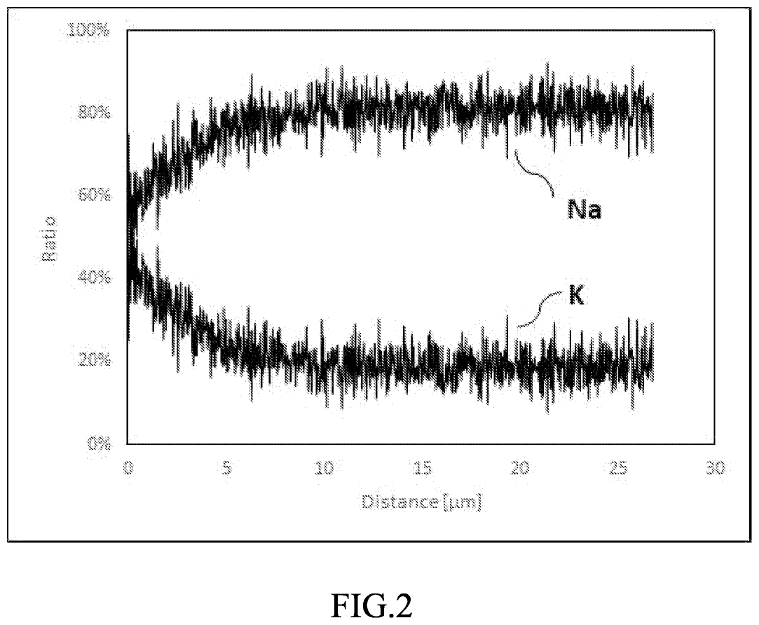

The glass substrate was immersed in a potassium nitrate (KNO₃) bath (K bath) or a sodium nitrate (NaNO₃) bath (Na bath) at the temperature and time listed in Table 2. Thereafter, in order to confirm whether a surface compressive stress layer was formed on the surface of the glass substrate, EDX-ray analysis was performed in a vertical depth direction from the outermost surface to the inside of the glass substrate. A scanning electron microscope (JSM-IT700HR) manufactured by JEOL Ltd. was used for the EDX-ray analysis. Among the EDX-ray analysis results of Example 5-A and Example 7-B, changes in the characteristic X-ray intensity ratio (ratio) resulting from sodium and potassium are shown in FIGS. 1 and 2, respectively. Further, in each of FIGS. 1 and 2, a horizontal axis represents the depth from the surface of the glass substrate. It can be seen that the characteristic X-ray intensity ratio (ratio) resulting from potassium is highest at the outermost surface of the glass substrate and decreases in a range from the outermost surface to the depth of about 10 μm. On the other hand, it can be seen that the characteristic X-ray intensity resulting from sodium increases in a range from the outermost surface of the glass substrate to a depth of about 10 μm. From the changes in the characteristic X-ray intensity ratio (ratio) resulting from potassium and sodium in FIGS. 1 and 2, it was confirmed that the salt bath caused ion exchange in the outermost surface of the glass substrate.

Further, table 2 also shows the results of the sandpaper falling ball test in which a 16.0 g SUS ball was dropped on each of these glasses.

TABLE 1

| | | | | | | | | | | Com. |
|---|---|---|---|---|---|---|---|---|---|---|
| | Ex. | | | | | | | | | Ex. |
| wt % | 1 | 2 | 3 | 4 | 5 | 6 | 7 | 8 | 9 | 1 |
| SiO₂ | 31.92 | 31.92 | 36.22 | 36.20 | 36.50 | 28.92 | 35.92 | 45.87 | 36.90 | 39.65 |
| B₂O₃ | | | | | | | | | | 14.01 |
| Al₂O₃ | | 4.00 | | | | | 3.00 | | | 4.79 |
| Y₂O₃ | | | | | | | | | | |
| La₂O₃ | | | | | | | | | | |
| TiO₂ | 28.91 | 28.91 | 29.14 | 29.13 | 29.37 | 34.91 | 17.91 | 21.88 | 28.89 | 0.02 |
| ZrO₂ | | | | 3.18 | 3.21 | | 3.00 | | 3.16 | |
| Nb₂O₅ | 8.50 | 8.50 | 8.58 | 8.57 | 8.64 | 8.50 | 13.50 | 7.49 | 9.21 | |
| WO₃ | | | | | | | | | | |
| MgO | | | | | | | | | 3.00 | |
| CaO | | | | | | | | | 1.00 | |
| BaO | 11.64 | 11.64 | 11.74 | 7.77 | 7.83 | 11.64 | 11.64 | 11.33 | | 41.03 |
| Li₂O | | | 0.77 | | | | | | | |
| Na₂O | 14.00 | 10.00 | 8.48 | 10.08 | 11.78 | 11.00 | 10.00 | 8.99 | 10.41 | 0.22 |
| K₂O | 5.00 | 5.00 | 5.04 | 5.04 | 2.63 | 5.00 | 5.00 | 4.00 | 7.41 | |
| Sb₂O₃ | 0.02 | 0.02 | 0.03 | 0.03 | 0.03 | 0.02 | 0.02 | 0.45 | 0.03 | 0.30 |
| TOTAL | 100.00 | 100.00 | 100.00 | 100.00 | 100.00 | 100.00 | 100.00 | 100.00 | 100.00 | 100.00 |
| Refractive index | 1.7552 | 1.7595 | 1.7701 | 1.7674 | 1.7717 | 1.8119 | 1.7175 | 1.6971 | 1.7470 | 1.5891 |
| (nd) | | | | | | | | | | |
| Abbe number | 27.30 | 26.10 | 26.25 | 25.91 | 25.80 | 24.00 | 30.04 | 30.79 | 26.68 | 61.14 |
| (νd) | | | | | | | | | | |
| Transmittance | 362 | 368 | 368 | 370 | 371 | 371 | 361 | 370 | 368 | 300 |
| (λ5) | | | | | | | | | | |
| Specific gravity | 3.18 | 3.16 | 3.18 | 3.13 | 3.15 | 3.26 | 3.17 | 3.03 | 2.98 | 3.31 |
| (ρ) | | | | | | | | | | |

TABLE 2

| | | | | [Height at which glass substrate |
|---|---|---|---|---|
| | | | | does not break (after chemical |
| | | | | strengthening)] − |
| | | Chemical | Ball drop test | [Height at which glass substrate |
| Glass | | strengthening | Average value | does not break (before chemical |
| composition | No. | condition | (n = 3) | strengthening)] |
| Ex. 3 | — | Not strengthened | 13.3 | — |
| | Ex. 3-A | Na bath 430° C. 6 h | 15.3 | 2.0 |
| | | K bath 430° C. 6 h | | |
| | Ex. 3-B | Na bath 480° C. 6 h | 16.7 | 3.3 |
| | | K bath 480° C. 6 h | | |
| Ex. 5 | — | Not strengthened | 10.7 | — |
| | Ex. 5-A | K bath 450° C. 6 h | 15.3 | 4.7 |
| Ex. 6 | — | Not strengthened | 10.0 | — |
| | Ex. 6-A | K bath 400° C. 7 h | 12.0 | 2.0 |
| | Ex. 6-B | K bath 450° C. 7 h | 12.7 | 2.7 |
| Ex. 7 | — | Not strengthened | 10.7 | — |
| | Ex. 7-A | K bath 400° C. 7 h | 12.7 | 2.0 |
| | Ex. 7-B | K bath 450° C. 7 h | 14.0 | 3.3 |
| Com. Ex. | — | Not strengthened | 12.0 | — |
| | Com. Ex. A | K bath 400° C. 6 h | 6.0 | −6.0 |

The chemically strengthened optical glasses of the Examples of the present disclosure was found to have impact resistance of 8 cm or more, as determined using the sandpaper falling ball test in which the 16.0 g SUS ball was dropped, while exhibiting a high refractive index.

In addition, it was revealed that each of the chemically strengthened optical glasses of the Examples of the present disclosure which exhibited a high refractive index, has impact resistance satisfying the expression,

$$[ Height at which glass substrate does not break ( after chemical strengthening ) ] - [ \text{} Height at which glass substrate does not break ( before chemical strengthening ) ] \geq 2. cm ,$$

as determined using the sandpaper falling ball test in which a 16.0 g SUS ball is dropped.

1. A chemically strengthened optical glass including a compressive stress layer as a surface layer, the chemically strengthened optical glass comprising, by mass % in terms of oxide:
20.0 to 50.0% of a SiO₂ component;
10.0 to 45.0% of a TiO₂ component; and
0.1 to 20.0% of a Na₂O component, wherein
the chemically strengthened optical glass has a refractive index (nd) of 1.65 to 1.85, and an impact resistance of 8 cm or more, as determined using a sandpaper ball drop test in which a 16.0 g SUS ball is dropped.

2. A chemically strengthened optical glass including a compressive stress layer as a surface layer, the chemically strengthened optical glass comprising, by mass % in terms of oxide:
20.0 to 50.0% of a SiO₂ component;
10.0 to 45.0% of a TiO₂ component; and
0.1 to 20.0% of a Na₂O component, wherein
the chemically strengthened optical glass has a refractive index (nd) of 1.65 to 1.85, and an impact resistance satisfying the following expression,
[Height at which glass substrate does not break (after chemical strengthening)]−[Height at which glass substrate does not break (before chemical strengthening)]≥2.0 cm,
as determined using a sandpaper ball drop test in which a 16.0 g SUS ball is dropped.

3. The chemically strengthened optical glass according to claim 1, further comprising, by mass % in terms of oxide:
3.0 to 20.0% of a Nb₂O₅ component; and
0 to 20.0% of BaO.

4. The chemically strengthened optical glass according to claim 1, further comprising, by mass % in terms of oxide:
0 to 15.0% of Al₂O₃;
0 to 15.0% of ZrO₂;
0 to 10.0% of Li₂O;
0 to 15.0% of K₂O; and
0 to 1.0% of Sb₂O₃.

5. The chemically strengthened optical glass according to claim 1, wherein the chemically strengthened optical glass has an Abbe's number (vd) of 20.0 to 33.0.

6. The chemically strengthened optical glass according to claim 2, further comprising, by mass % in terms of oxide:
3.0 to 20.0% of a Nb₂O₅ component; and
0 to 20.0% of BaO.

7. The chemically strengthened optical glass according to claim 2, further comprising, by mass % in terms of oxide:
0 to 15.0% of Al₂O₃;
0 to 15.0% of ZrO₂;
0 to 10.0% of Li₂O;
0 to 15.0% of K₂O; and
0 to 1.0% of Sb₂O₃.

8. The chemically strengthened optical glass according to claim 3, further comprising, by mass % in terms of oxide:
0 to 15.0% of Al₂O₃;
0 to 15.0% of ZrO₂;
0 to 10.0% of Li₂O;
0 to 15.0% of K₂O; and
0 to 1.0% of Sb₂O₃.

9. The chemically strengthened optical glass according to claim 2, wherein the chemically strengthened optical glass has an Abbe's number (vd) of 20.0 to 33.0.

10. The chemically strengthened optical glass according to claim 3, wherein the chemically strengthened optical glass has an Abbe's number (vd) of 20.0 to 33.0.

11. The chemically strengthened optical glass according to claim 4, wherein the chemically strengthened optical glass has an Abbe's number (vd) of 20.0 to 33.0.
